(19) United States
(12) Patent Application Publication
(10) Pub. No.: US 2016/0164174 A1
(43) Pub. Date: Jun. 9, 2016

(54) PHASED ARRAY STEERING

(71) Applicant: RAYTHEON COMPANY, Waltham, MA (US)

(72) Inventor: Johan A. Kullstam, Marlborough, MA (US)

(73) Assignee: RAYTHEON COMPANY, Waltham, MA (US)

(21) Appl. No.: 14/561,937

(22) Filed: Dec. 5, 2014

(51) Int. Cl. H01Q 3/34

(52) U.S. Cl. CPC H01Q 3/34

(57) ABSTRACT

An antenna array system includes a plurality of antenna array elements and an array controller in communication with each of the array elements. Each array element further includes an antenna, a computing device, and a storage device maintaining a position vector uniquely identifying the position of its antenna within the array. The array controller broadcasts, to each array element, a signal including a direction vector representative of a desired beam steering direction. Employing their respective computing devices, each array element calculates its phase based upon stored position vector and the received direction vector. The antenna of each array element further emits an electromagnetic wave based upon its calculated phase. The net electromagnetic wave resulting from combination of the respective emissions of the antenna array elements is aligned with the desired beam steering direction.

### BACKGROUND

Antenna arrays are groupings of many antennas in a defined pattern, where each antenna of the array generates an electromagnetic wave. Due to interference of the waves generated by each antenna, the net electromagnetic wave generated by the array is enhanced or reduced in selected directions, “steering” the net electromagnetic wave. Antenna arrays which achieve this interference by varying the phase of the electromagnetic waves generated by each antenna are referred to as phased antenna arrays or phased arrays.

As the antennas of a phased array are separated in space, in order to steer the net electromagnetic wave of the array, each antenna broadcasts an electromagnetic wave with a distinct phase shift, based upon its location within the array. Phased arrays typically employ a master computer in communication with the antennas of the array for this purpose. The master computer computes the phase shift required for each antenna and sends this information to the appropriate antenna.

This manner of phased array steering is problematic, however. In one aspect, a great deal of computation is performed by the master computer. In another aspect, a great deal of information is transmitted from the master computer to each antenna. Each of these aspects may increase the cost and complexity of the phased array.

Accordingly, there is an ongoing need for improved phased array systems and methods of operation.

### SUMMARY

In an embodiment, a method of beam steering in a phased array is disclosed. The method includes: storing, by a first antenna array element, a first position vector, x₁, representing a position of an antenna of the first antenna array element with respect to a defined origin and coordinate system; storing, by a second antenna array element, a second position vector, x₂, representing a position of an antenna of the second antenna array element with respect to the defined origin and coordinate system; broadcasting, by an array controller, a signal including a direction vector, u, to each of the first and second antenna array elements, where the direction vector is representative of a command steering direction; calculating, by one or more first processors of the first array antenna element, a first phase, φ₁, based upon the first position vector and the direction vector; and calculating, by one or more second processors of the second array antenna element, a second phase, φ₂, based upon the second position vector and the direction vector.

In further embodiments, the method may include one or more of the following, in any combination.

In an embodiment of the method, storing the first position vector by the first antenna array element includes storing the first position vector in a first storage device in communication with the first antenna array element and where storing the second position vector by the second antenna array element comprises storing the second position vector in a second storage device in communication with the second antenna array element, where the first and second storage devices are different.

In an embodiment, the method further includes: emitting, by the first antenna, a first electromagnetic wave based upon the first phase; and emitting, by the second antenna, a second electromagnetic wave based upon the second phase.

In an embodiment of the method, the first phase is calculated according to Formula (1) and the second phase is calculated according to Formula (2), Formulas (1) and (2) given by:

$$\begin{matrix}{φ}_{1} = ( \frac{2 π}{λ} ) ( \frac{{x}_{1} \cdot u}{\vert u \vert} ) & ( 1 ) \\ {φ}_{2} = ( \frac{2 π}{λ} ) ( \frac{{x}_{2} \cdot u}{\vert u \vert} ) & ( 2 )\end{matrix}$$

where λ is the wavelength of the first and second electromagnetic waves.

In an embodiment of the method, the position vectors x₁ and x₂ and the direction vector u are represented in a Cartesian coordinate system. The “dot” between x and u is the dot product which is also known as the scalar product between vectors.

In an embodiment of the method, vectors x₁ and x₂ and the direction vector u are not represented in an Euler angle-based coordinate system.

In an embodiment of the method, broadcasting the signal including the direction vector further includes broadcasting the signal simultaneously to the antennas of the first and second antenna array elements.

In an embodiment of the method, calculating the first phase and the second phase does not include calculating the first phase and the second phase by the array controller.

In another embodiment, a phased array is disclosed. The phased array includes: an antenna array including a plurality of antenna array elements and an array controller adapted to broadcast, to each of the plurality of antenna array elements, a signal including a direction vector, u, where the direction vector represents a selected steering direction of the antenna array. Each antenna array element further includes: an antenna; a storage device adapted to maintain a position vector, x, representing a position of the antenna with respect to a defined origin and the direction vector, u; and a computing device in communication with the storage device, the computing device adapted to calculate a phase φ for the antenna of its antenna array element based upon the position vector of the antenna of its antenna array element and the direction vector.

In further embodiments, the phased array may include one or more of the following, in any combination.

In an embodiment of the phased array, the array controller is adapted to broadcast the direction vector to each of the plurality of antenna array elements simultaneously.

In an embodiment of the phased array, each antenna of the plurality of antenna array elements is further adapted to output an electromagnetic wave based upon the respective phase calculated by its computing device.

In an embodiment of the phased array, the phase of the i^{th} antenna array element is calculated, by the computing device of the i^{th} antenna array element, according to Formula (1):

$${φ}_{1} = ( \frac{2 π}{λ} ) ( \frac{{x}_{1} \cdot u}{\vert u \vert} ) \qquad ( 1 )$$

where: φᵢ is the phase calculated by the i^{th} computing device of the i^{th} antenna array element; λ is the wavelength of the electromagnetic wave output by the antenna of the i^{th} antenna array element; and xᵢ is the position vector of the antenna of the i^{th} array element.

In an embodiment of the phased array, at least a portion of the antennas of the plurality of array elements are not spaced according to a regular pattern.

In an embodiment of the phased array, at least a portion of the antennas of the plurality of array elements are not positioned within a single plane.

In an additional embodiment, a non-transitory computer-readable medium having computer-executable program codes embedded thereon for steering a phased array is disclosed. The computer-readable program codes includes instructions that, when executed by one or more processors, cause the one or more processors to: store, at a first antenna array element, a first position vector, x₁, the first position vector representing the position of an antenna of the first antenna array element with respect to a defined origin; store, at a second antenna array element, a second position vector x₂, the second position vector representing the position of an antenna of the second antenna array element with respect to the defined origin; broadcast, to each of the first and second antenna elements, a direction vector, u, representative of a command steering direction; calculate, at the first antenna system, a first phase, φ₁, based upon the first position vector and the direction vector; and calculate, at the second antenna system, a second phase, φ₂ based upon the second position vector and the direction vector.

Embodiment of the non-transitory computer readable medium may include one or more of the following, alone or in combination.

In an embodiment of the non-transitory computer readable medium, the computer-readable program codes further includes instructions that, when executed by the one or more processors, cause the antenna of the first antenna array element to emit a first electromagnetic wave based upon the first phase and cause the antenna of the second antenna array element to emit a second electromagnetic wave based upon the second phase.

In an embodiment of the non-transitory computer readable medium, the computer-readable program codes further includes instructions that, when executed by the one or more processors, cause the first phase to be calculated according to Formula (1) and the second phase is calculated according to Formula (2), Formulas (1) and (2) given by:

$$\begin{matrix}{φ}_{1} = ( \frac{2 π}{λ} ) ( \frac{{x}_{1} \cdot u}{\vert u \vert} ) & ( 1 ) \\ {φ}_{2} = ( \frac{2 π}{λ} ) ( \frac{{x}_{2} \cdot u}{\vert u \vert} ) & ( 2 )\end{matrix}$$

where λ is the wavelength of the electromagnetic wave emitted by the first and second antenna arrays.

In an embodiment of the non-transitory computer readable medium, the first and second position vectors and the direction vector are represented in a Cartesian coordinate system.

In an embodiment of the non-transitory computer readable medium, the first and second position vectors and the direction vector are not represented in an Euler angle-based coordinate system.

In an embodiment of the non-transitory computer readable medium, the computer-readable program codes further includes instructions that, when executed by the one or more processors, causes the direction vector to be broadcast simultaneously to the first and second antenna array elements.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is an operating environment of an embodiment of a phased array system of the present disclosure;

FIG. 2 is a schematic block diagram of an embodiment of information flow between an array controller and an antenna element of the array;

FIG. 3 is a illustration of an embodiment of a single array element of the phased array of FIG. 1;

FIG. 4 is a schematic illustration of an embodiment of a two array elements of the phased array of FIG. 1;

FIG. 5 is a schematic illustration of an embodiment of the phased array of FIG. 1 in a linear array configuration;

FIG. 6A illustrates hex grid coordinates of antenna array elements in two-dimensions for a flat panel array;

FIG. 6B is a three dimensional plot displaying amplitude for each array element as a function of its position given by the hex grid coordinates of FIG. 6B;

FIG. 6C illustrates element array placement divided into two planar, hexagonal arrays, Panel 1 and Panel 2; and

FIGS. 7A-7C illustrate beam patterns for embodiments of the planar, hexagonal arrays of FIG. 6C; (A) Panel 1; (B) Panel 2; (C) Panel 1 and 2 combined.

### DETAILED DESCRIPTION

Phased antenna arrays typically include many antenna array elements, with each antenna array element individually receiving a phase shift appropriate for the desired beam steering direction by a master controller. Centralized computation and transmission of the phase shift for each array element from the master controller results in a number of undesirable drawbacks. Notably, phases are typically generated based upon spherical coordinates (e.g., rotations about the axes of a fixed coordinate system) using computationally intensive trigonometry operations. The master controller is tasked with handling this computational load alone, as well as transmitting the large number of computed phase shifts to respective array elements. To perform these objectives requires a relatively sophisticated and costly computing device for use as the master controller. Furthermore, there are inherent time delays associated with transmission of the computed phases from the master controller to the array elements, increasing the time required for the array as a whole to change from one beam steering direction to another.

Embodiments of the disclosure provide an improved phase array system which addresses these and other deficiencies of present phased array designs. The phased array system may include an antenna array having a plurality of antenna array elements and an array controller. Each of the antenna array elements may further include an antenna, a computing device, and a storage device, in communication with one another. The storage device maintains a location vector that uniquely identifies the location of its corresponding antenna.

During operation, the array controller transmits or broadcasts a direction vector to each of the antenna array elements. The direction vector represents a desired array steering direction (e.g., the direction of maximum gain of the net electromagnetic wave generated by the array). At each antenna element, the antenna computing device receives the direction vector and the position vector and calculates the phase shift for the antenna element. This phase shift is subsequently transmitted to the antenna in a command that commands generation of an electromagnetic wave by the antenna based upon the calculated phase. As discussed in greater detail below, the calculated phase may be further modified by a gain and/or combined with other phase compensation terms prior to transmission to the antenna.

In conventional phased arrays, the phase shifts are calculated using Euler angles (as opposed to a Cartesian vector formulation), which involves difficult trigonometric calculations and necessitates the use of a relatively powerful computing device (e.g., a master controller). As a result, all phase shift calculations are performed at the master controller and transmitted to the antenna elements. In contrast, embodiments of the disclosed phased array system represent the location vector and the direction vector as matrix vectors in the same coordinate system. These representations allow the phase shift for an antenna array element to be calculated by using a dot product. The dot product is a simple calculation, involving multiplication and addition operations, as compared to more computationally intensive trigonometric calculations. As a result, the phase calculation for a given antenna may be performed by a relatively simple computing device, incorporated in each local antenna array element, rather than a more sophisticated, remote master controller.

Moving computation of the antenna phase shift to the antenna array element also provides a number of advantages. In one aspect, as the phase shift calculation is relatively easy, a low-cost computing device can be employed to perform this calculation, reducing the cost of the phased array. Furthermore, as the array controller broadcasts a single direction vector to all array elements, the amount of signal traffic transmitted to the array elements is significantly reduced, as compared to a master controller that transmits each phase shift to each of the array elements. As a result, the transmission capacity required between the array controller and the antenna elements may be reduced, further lowering the cost of the phased array. Additionally, with fewer signals transmitted between the array controller and the antenna elements, delays due to transmission time may be reduced, increasing the response time of the phased array to changes in beam steering (i.e., the direction vector).

In further advantage, as discussed in greater detail below, embodiments of the disclosed phase array may be employed with arrays of any configuration. Notably, phase shift calculations employing Euler angles are rendered more difficult as the array symmetry is reduced and/or the array dimension is increased (e.g., 1-D lines to 2-D panels to 3-D topologies). Thus, antenna arrays having symmetry and/or regular patterns are preferred when employing Euler angles in order to reduce computational complexity. In contrast, the matrix vector representation employed in embodiments of the present disclosure is general. That is to say, dot matrix calculation of phase shifts can be employed with any possible arrangement of array elements, regardless of their dimensionality or pattern (regular pattern, semi-regular pattern, irregular pattern, random pattern, etc.).

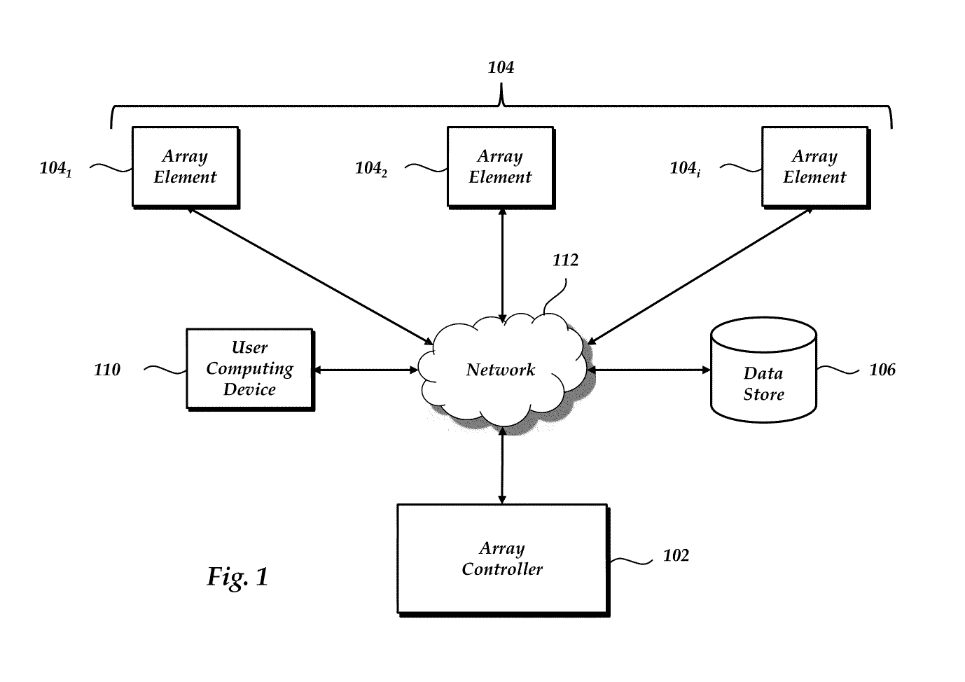

With reference to FIG. 1, an embodiment of a phased array system 100 for generating a directed electromagnetic wave is illustrated. The system 100 includes an array controller 102 in communication with a plurality of antenna array elements 104₁, 104₂, . . . 104ᵢ, collectively antenna array elements 104, a data store 106, and a user computing device 110 via a network 112.

As discussed in greater detail below, the data store 106 may be any device capable of maintaining computer-readable information. The data store 106 may further represent a plurality of storage devices, physically or logically connected to respective elements of the system 100.

Each of the antenna array elements 104 may include at least one antenna adapted to generate an electromagnetic wave having a selected amplitude, frequency, and phase. The antenna array elements 104 may also include a dedicated storage device (e.g., not shared with another array element) for storage of the position vector of the antenna and the direction vector. The antenna array elements 104 may further include an antenna computing device adapted to perform phase shift calculations based upon the position vector and direction vector for the antenna.

A user may employ his or her user computing device 110 to communicate with the array controller 102 and provide the array controller 102 with a desired beam steering direction of a net electromagnetic wave to be generated by the antenna array elements 104. For example, the array controller 102 may maintain or generate one or more user interfaces capable of display by the array controller 102 and/or the user computing device 110 for allowing the user to provide the desired beam steering direction. Upon receipt, the array controller 102 may store the direction vector (e.g., in the data store 106).

The array controller 102 may further transmit the direction vector to each of the antenna array elements 104. In certain embodiments, this transmission may be made simultaneously to all of the antenna array elements 104. In response, each of the i antenna array elements 104 (e.g., the antenna computing device) may calculate the phase shift for its antenna. Subsequently, each of the array elements (e.g., the antenna) may further generate respective electromagnetic waves. Such electromagnetic waves may be generated at a selected time after transmission of the direction vector or at a time selected by the user. Owing to the respective phase shift of each of these electromagnetic waves, their mutual interference results in a net electromagnetic wave having a maximum amplitude aligned with the direction vector.

In certain embodiments, the direction vector and the position vector may be represented as vectors with respect to a defined origin and coordinate system. The direction vector and position vectors will be referred to herein as u and x, respectively. As discussed in greater detail below, embodiments may be discussed in the context of an orthonormal coordinate system having an origin at a defined position within this coordinate system. In certain embodiments, the origin and coordinate system may be selected in symmetry of the phased array. While the phase shift calculations are relatively simple when performed using the vector approach of the disclosed embodiments, selection of an origin and coordinate system in symmetry with the phased array may further simplify the phase shift calculations. In alternative embodiments, the direction vector provided by the user may be converted (e.g., by the array controller 102) into a matrix vector with respect to the defined origin and coordinate system.

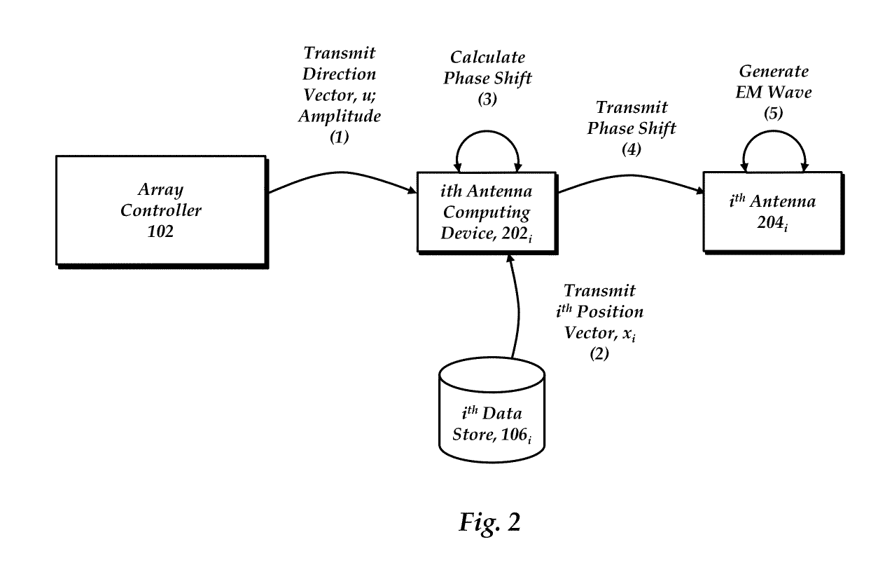

With reference to FIG. 2, generation of a steered beam according to embodiments of the disclosure will now be discussed in detail. The array controller 102 may receive a direction vector (e.g., from the user computing device) and transmit the direction vector to one or more of the antenna array elements 104. For clarity, reference will be made to the i^{th} antenna array element, 104ᵢ. However, it may be understood that the description and discussion with respect to antenna array element 104ᵢ may be applicable to each of the antenna array elements 104. The antenna array element 104ᵢ includes a data store 106ᵢ, one or more antenna computing devices 202ᵢ, and an antenna 204ᵢ.

The array controller 102 may also transmit a group key, j, to all i antenna array elements 104. The group key code identifies a subset of the full array of elements. Since each of the antenna array elements 104 can have different key codes, a variety of different sub arrays may be designated. For example, given an array of 16 group codes, this would allow for 16 different array patterns. The pattern to be employed can be identified in the message broadcasting the direction vector, u.

The data store 106ᵢ may be any data storage device capable of maintaining computer-readable data. Examples may include, but are not limited to, magnetic storage (e.g., magnetic tape, magnetic disks, etc.), optical storage,(e.g., CD, DVD, etc.), solid state storage (e.g., flash memory, etc.) and other computer-readable media known in the art.

The antenna computing device 202ᵢ may be any computing device having one or more processors. The antenna computing device 202ᵢ may be in communication with the array controller 102. The antenna computing device 202ᵢ may be in further communication with the other components of the i^{th} antenna array element 104ᵢ (e.g., data store 106ᵢ and the antenna 204ᵢ). The antenna computing device 202ᵢ may receive the direction vector, u, from the array controller 102. In alternative embodiments, not illustrated, the array controller 102 may communicate the direction vector to the data store 106ᵢ for storage. Once stored in the data store 106ᵢ, the direction vector may be subsequently retrieved by the antenna computing device 202ᵢ.

The antenna computing device 202ᵢ may further receive its position vector, xᵢ, from the data store 106. The position vector is the unique position of antenna 204ᵢ, with respect to the defined origin and coordinate system, and may also be represented as a matrix vector. Receipt of the position vector, xᵢ, by the antenna computing device 202ᵢ may take place before, after, or concurrently with receipt of the direction vector, u. In an embodiment, the position vector, xᵢ, may be provided to the data store 106ᵢ by the user and stored until required by the antenna computing device 202ᵢ. In alternative embodiments, the position vector, xᵢ may be provided to the data store by a computer-implemented location device (e.g., a computing device capable of accessing a global positioning system, etc.).

The antenna computing device 202ᵢ may employ both the direction vector, u, and the position vector, xᵢ, to calculate the phase shift, φ₁, appropriate to antenna 204. This phase shift, φᵢ, may be further transmitted from the antenna computing device 202ᵢ to the antenna 204ᵢ in a command that commands generation of an electromagnetic wave having a selected wavelength, λ, or frequency, ν, and the phase shift, φᵢ, by the antenna 204ᵢ. In an embodiment, the calculated phase shift may be directly transmitted to the antenna 204ᵢ from the antenna computing device 202ᵢ. In alternative embodiments (not shown), the calculated phase shift may be transmitted to the data store by the computing device for storage. The calculated phase shift may be subsequently transmitted from the data store to the antenna for generation of the electromagnetic wave by the antenna.

Operations performed by the antenna computing device 202ᵢ for calculating the phase shift, φᵢ, for the i^{th} antenna element will now be addressed. As discussed above, in an embodiment, the direction vector, u, and position vector, xᵢ, received by the antenna computing device 202ᵢ are represented in an orthonormal coordinate system. For the purpose of discussion, the phase shift calculations will be discussed in terms of a three-dimensional coordinate system. However, it may be understood that any orthonormal coordinate system of greater or fewer dimensions may be employed without limit.

### Selection of a Suitable Orthonormal Coordinate System

In an embodiment, an origin point is selected and an orthonormal coordinate system is defined. The selection of origin point and orthonormal coordinate system may be arbitrary or based upon the configuration of the phased array. For example, in certain embodiments, it may be desirable to choose the origin and coordinate system in symmetry with the phased array.

### Obtaining the Position Vector

As discussed above, respective position vectors may be provided to the antenna array elements 104. In a three-dimensional, orthonormal representation, the position vector, xᵢ, may be represented, or converted to be represented, as a row vector, as illustrated below:

xᵢ=(xᵢ₁ xᵢ₂ xᵢ₃)

where each column of the row vector represents an orthonormal dimension (e.g., 1, 2, 3) in some length unit.

Matrix processing may be exploited to handle common operations. For example, it may be useful to stack the element row vectors into a two-dimensional matrix having a column for each of the orthonormal dimensions and a row for each element in the array. For example, an array having three elements would possess three rows and three columns:

| | | | |
|---|---|---|---|
| Array Element 1 | x₁₁ | x₁₂ | x₁₃ |
| Array Element 2 | x₂₁ | x₂₂ | x₂₃ |
| Array Element 3 | x₃₁ | x₃₂ | x₃₃ |

Often, it is desirable to rotate the array coordinate system from other coordinate systems related to steering. It is possible to transform the array matrix to a new coordinate system, multiplying by a rotation matrix from the right. This will rotate each row by the rotation matrix to coordinates in the new coordinate system.

### Obtaining the Direction Vector

The direction vector, u, may be provided to, or produced by, the array controller 102 and further transmitted to the antenna array elements 104. The array controller may further provide an amplitude profile to all elements in the array, as discussed in greater detail below. The direction vector may be represented, or converted to be represented, in the three-dimensional coordinate system as a row vector:

u=(u₁ u₂ u₃)

where each column of the row vector represents one of the orthonormal dimensions (e.g., 1, 2, 3). In an embodiment, the direction vector may be assumed to possess unit length, i.e., u₁²+u₂²+u₃²=1.

### Calculating the Phase Advance

By calculating the dot product of the direction vector and position vector of each array element, it is possible to determine the phase advance for each antenna. This dot product is given by:

$$\begin{matrix}u \cdot {x}_{i} = ( \begin{matrix}{u}_{1} & {u}_{2} & {u}_{3}\end{matrix} ) \cdot ( \begin{matrix}{x}_{i 1} & {x}_{i 2} & {x}_{i 3}\end{matrix} ) \\ = {u}_{1} {x}_{i 1} + {u}_{2} {x}_{i 2} + {u}_{3} {x}_{i 3}\end{matrix}$$

By applying the opposite phase shift at each element (modified by any gain or additional phase compensation, as necessary), the coherent sum of the signals from each element is maximally constructive in the direction of the direction vector u, thereby achieving beam steering.

In further embodiments, it may be understood that each array element has a (real) gain factor that may be a function of the direction vector and array orientation. These gains may be applied to the signals at each element.

For gain in other directions, the phase advance may be left fixed. The phase advance is calculated by the dot products between the direction vector and position vectors of the array elements. The phase due to the steering direction and the element gains are further applied. In certain embodiments, this sum is likely to exhibit only partial constructive coherent combining. As a result, gain will be observed in directions other than the direction of the direction vector. By using a grid of steering directions, it is possible to describe the antenna pattern of the phased array.

As discussed in greater detail below, phase changes may arise due to factors not accounted for in the phase advance calculations discussed above. For example, transmission delays may give rise to additional phase changes. It may be desirable in certain embodiments to compensate for these phase changes in order to achieve the desired beam steering. Accordingly, the phase advance calculated according to the disclosed embodiments may be combined with one or more additional phase compensations. The net phase resulting from this combination may be provided to respective antennas for generating the electromagnetic wave for that antenna element.

Beneficially, embodiments of the disclosed dot-product beam steering lend themselves to decentralized processing. By providing the ability for each antenna array element 104 to store its own position vector, xᵢ, at its own location and perform its own dot product operation for calculating its phase shift, φᵢ, then broadcast of a steering command (e.g., the direction vector) is possible. There is no individual phase shift command to produce or send by the array controller 102. This allows communication between the array controller 102 and the antenna array elements 104 using a simple shared command “bus” in which all the antenna array elements 104 receive the direction vector simultaneously.

In further benefit, embodiments of the beam steering approach discussed herein do not require any particular shape of the antenna array. The elements may be spaced according to a regular pattern or placed arbitrarily. Thus, while arrays having greater symmetry (e.g., placed on a line or in a single plane) may be exploited to simplify the phase shift calculations, such configurations are not required to employ embodiments of the disclosed beam steering approach.

Embodiments of the disclosed beam steering approach are further illustrated in detail below in the context of different array configurations. Examples 1-3 present examples of 1-dimensional arrays. Example 1 presents the case of an array having a single element. Example 2 presents the case of an array having two elements. Example 3 presents the case of an linear array, with elements positioned along a line. Example 4 presents the case of a 2-dimensional array (e.g., flat panel).

### EXAMPLE 1

### Single Element Pointing Geometry

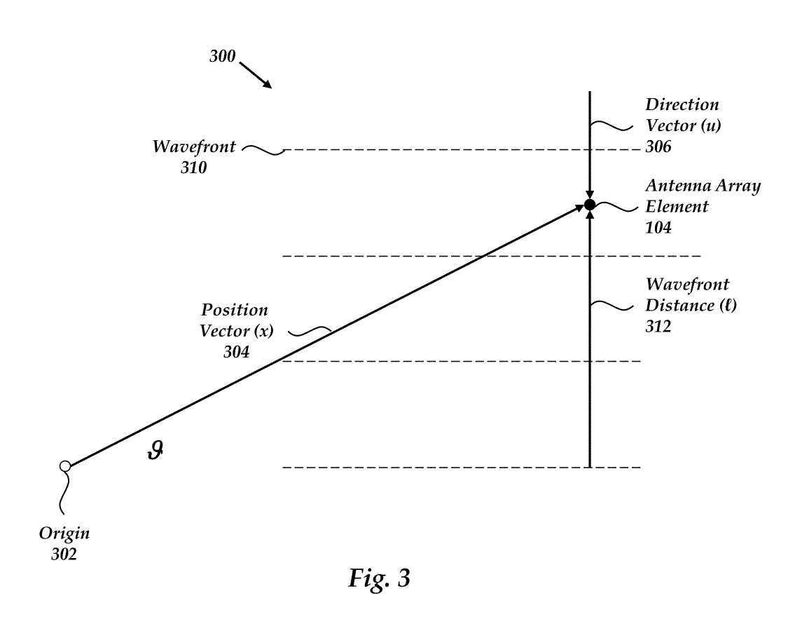

With reference to FIG. 3, a single element array environment 300 is illustrated. While a single element is not sufficient to make a directional array, it is a useful example for cleanly describing the per-element geometry. Assume the position vector 304 is the vector pointing from the origin 302 to an antenna array element 104 and given by x (no subscript is necessary to identify the array element, as only one array element is present). Further assume the direction vector 306 is a vector which points in the direction of the signal travelling towards the antenna array element 104 and is given by u. Additionally assume a wavefront 310 and wavefront distance 312, l representing the distance in which the phase is advanced at the array element 104 with respect to the origin point.

In general, the electromagnetic wave equation can be written as given in Equation 1.1:

v(t)=exp(2πft−kx) (1.1)

where exp is the exponential function, f is the frequency of the electromagnetic wave, k is the propagation constant, 2π/λ, λis the wavelength of the electromagnetic wave, and x is position. The phase advance due to placement of antenna array element 104 at position x and signal direction u is given by the inner product between x and u, Equation (1.2):

$$\begin{matrix}𝓁 = x \cdot u \\ = \vert x \vert sin ϑ \\ = \frac{x \cdot u}{\vert u \vert}\end{matrix} \qquad ( 1.2 )$$

where Θ is the angle between the element position vector and the signal wavefront. The signal wavefront is orthogonal to the direction vector. Given the length difference l, and using the propagation constant k=2π/λ, the phase φ can be written as φ=kl

Equation 1.2 may be further simplified. In one example, denoting the direction of the signal by a unit length vector, such that |u|=1, the denominator of Equation 1.2 becomes 1 and vanishes. Unless otherwise noted, it may be assumed, in this and subsequent examples, that the direction vector possesses unit length (i.e., |u|=1) and the phase advance due to element location is φ=kl.

In another example, by choosing length units for x such as wavelength or phase in radians, then the Equation 1.2 further simplifies. For example, λ may be expressed in the same distance unit as x. Using the propagation constant in the form k=2π/λ converts this distance to radians. In alternative embodiments, different, equivalent forms of the propagation constant may be employed to convert the phase distance unit into quantities other than radians. In one example, using the propagation constant in the form k=360/λ, the phase distance unit may be expressed as degrees. In another example, using the propagation constant in the form k=32/λ, the phase distance unit may be expressed as phase settings.

It may be observed that this simplifying assumption is valid only for fixed wavelengths. For arrays operating over multiple frequencies, and hence over multiple wavelengths, this simplification may be omitted, as it may fail to provide appreciable optimization.

### EXAMPLE 2

### Two Element Pointing Geometry

It may be understood that in actual arrays, multiple array elements are present, each with its own position vector, xᵢ. For a particular steering direction, all elements of the array are phase compensated such that all elements give the same net phase when combined. That is to say, the phase is adjusted to account for the phase advance due to the array geometry, according to embodiments discussed herein, as well as any other phase changes.

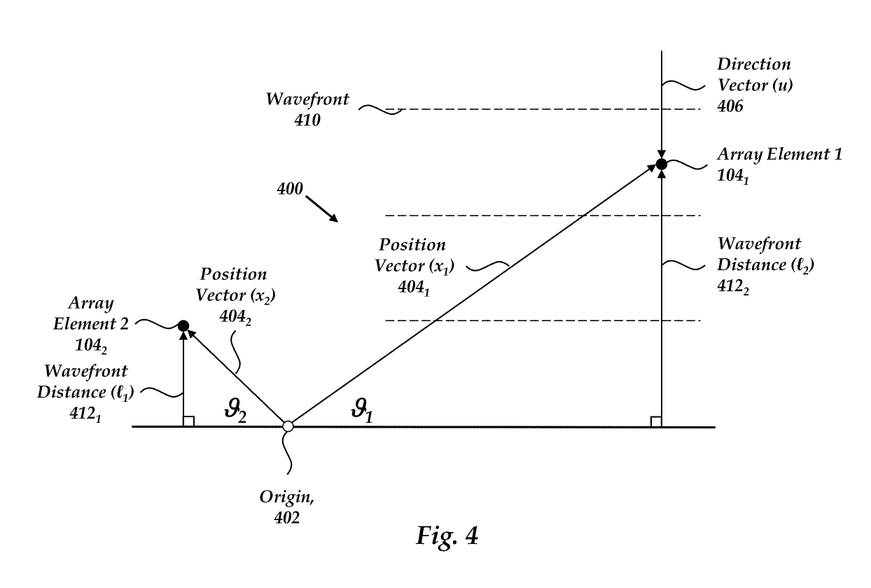

An embodiment of a two-element array environment 400 is illustrated in FIG. 4. Assume the position vector 404₁ is the vector pointing from the origin 402 to a first antenna array element 104₁ and given by xᵢ. Assume the position vector 104₂ is the vector pointing from the origin 402 to a second antenna array element 104₂ and given by x₂. Further assume the direction vector 406 is a vector which points in the direction of the signal travelling towards the antenna array elements 104₁ and 104₂ and is given by u. Additionally assume a wavefront 410 and wavefront distances 412₁ (l₁) and 412₂ (l₂), representing the distances in which the phase is advanced at the first and second array elements, respectively with respect to the origin point.

To combine the electromagnetic waves generated from two array elements, there is some amount of transmission delay due to the physical construction of the array. Such delays may be different for each array element and create phase changes not accounted for in the phase advance calculation discussed herein.

To estimate the compensation needed to account for such phase changes, it may be assumed that these differences are constant for the antenna array environment. Furthermore, the fixed transport delay may be compensated for by the phase shifter at each element. Such phase compensation may be performed for each array element in advance of electromagnetic wave generation and stored in its respective data storage device. When generating an electromagnetic wave, this phase compensation may be combined with the calculated phase change, and any other phase compensations, as necessary, to determine the net phase change to be employed in generating the electromagnetic wave for the array element. Thus, by virtue of the array calibration it is possible, without loss of generality, to assume that the transport delay is zero.

The signal, r, from two antennas is given by Equation 1.4:

r=a₁exp[j(kx₁·u+φ₁)]+a₂exp[j(kx₂·u+φ₂)] (1.4)

where a, (e.g., a₁, a₂) is the gain at each element, k is the propagation constant (i.e., 2π/λ), j is group key, and φᵢ (e.g., φ₁, φ₂) is the net phase element of each element (phase offset position, transport delay, and any other phase compensation). It is further assumed that the direction vector, u, is normalized to a unit length of |u|=1). Often the elements have a gain which is dependent upon direction of arrival aᵢ=a(u).

Maximum gain is achieved when the phases of the signals emitted from each element agree, as illustrated in Equation 1.5:

kx₁·u+φ₁=kx₂·u+φ₂ (1.5)

When array elements are in different locations, x₁ ≠ x₂, the conditions of Equation 1.5 are only met for a distinct direction u, the commanded steering direction of the array.

### EXAMPLE 3

### Linear Array

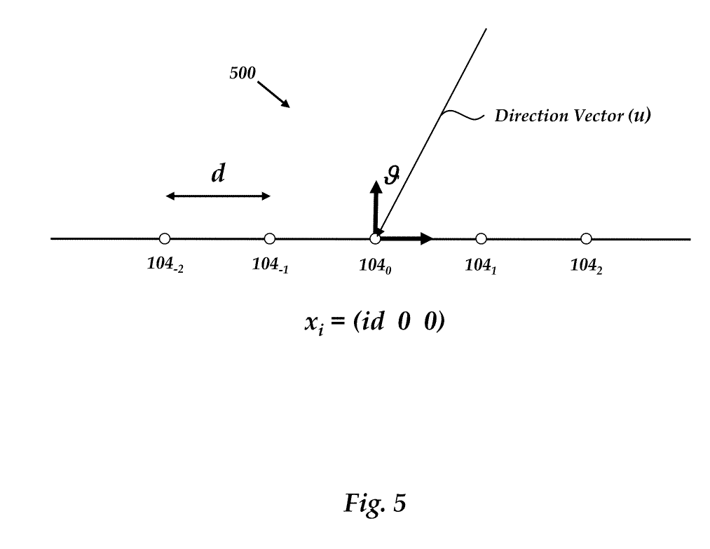

In a linear array, as illustrated in FIG. 5, the array elements are regularly spaced along a line. Assume the origin is positioned on this line. Further assume a coordinate basis with first component aligned with the linear array and the third component normal to the array. In this example, there will be no activity in the second component.

In the example of FIG. 5, there are five elements, each spaced apart by distance d. The array elements are at xᵢ=(id 0 0) with i=−2, −1, 0,+1, +2, respectively. The direction vector has a scan angle of Θ, from perpendicular to the array. As a vector, the scan angle Θ corresponds to:

u=(sin Θ 0 cos Θ)

The dot product between element location vector and array element is given by Equation 1.6

u·xᵢ=id sin Θ (1.6)

With the substitution of ξ=sin Θ, where ξ is the “sine-space coordinate,” valid pointing directions have −π/2<Θ<+π/2 and −1<ξ<+1. For an array of omni-directional antennas, the third component ±cos Θ can have either sign.

For a flat panel array, there is a cosine geometry loss on the front side and zero on the back side. The cosine cos Θ can also be expressed by the vector notation, Equation 1.7:

a=cos Θ=u·z=(sin Θ 0 cos Θ)·(0 0 1) (1.7)

where z=(0 0 1) is normal to the array.

### EXAMPLE 4

### Flat Panel

For a flat panel, one exemplary embodiment can have a coordinate system with two axes in the plane of the array. Thus, every element will have a position of the form x=(x₁ x₂ 0). The direction vector u=(u₁ u₂ u₃) can be non-zero in any or all of the dimensions. However, the third component of the direction vector, u₃, plays no role in the dot product, as illustrated in Equation 1.8:

u·x=u₁x₁+u₂x₂+0u₃=u₁x₁+u₂x₂ (1.8)

The two-dimensional sine space representation of the unit direction vector is simply the first two components of u, u₁, u₂, and is often notated as u, v -space. Sine-space is therefore a simple dropping of the third component, since it is always multiplied by the zero in the dot product.

### EXAMPLE 5

### Coherent Addition of Multiple Flat Panel Arrays

In a further example, phases will be discussed for a pair of flat panel arrays which are to be coherently combined. Each array has a hex-grid of array elements. As discussed in greater detail below, the hex-grid of elements is created, then rotated, and the coordinates translated. Rotation and translation is performed twice, once for a first panel (e.g., a north facing panel) and once for a second panel (e.g., an east facing panel). A rotationally symmetric Taylor amplitude weight is used for apodization or side-lobe control. A cosine amplitude roll-off is also used in pointing away from broadside. The two panels are combined into a 3-D array by concatenating all the element coordinates. The phases are further set to steer to a point visible to both panels. The gain for the steering is taken as the sum of amplitudes, as the phases will all be the same from every element. To make the beam pattern, the deflections away from the pointing direction are examined and the gain plotted.

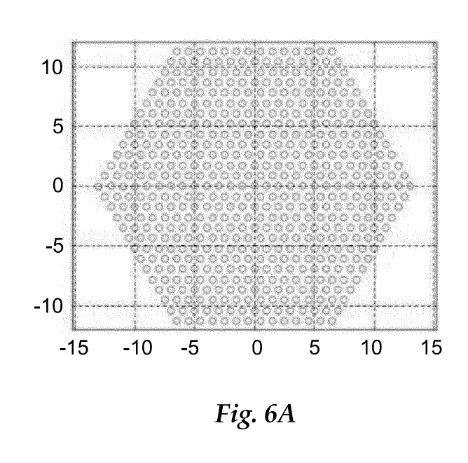

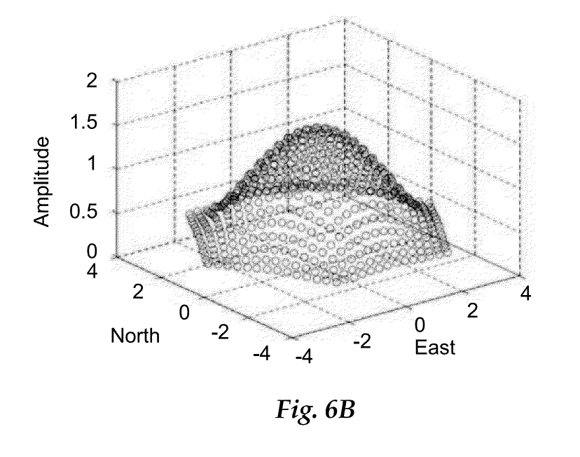

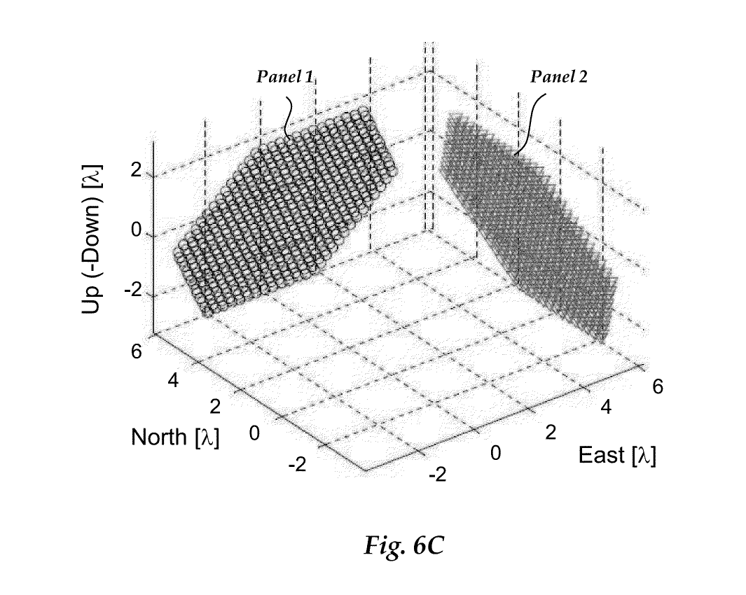

An example set of Hex grid coordinates is shown below in Table 1 and further illustrated in FIG. 6A. The elements are spaced by 1 unit apart and laid within a plane at specified points to the north and east. The total diameter is approximately 22.5 units. There is no vertical extent at this point. As discussed below, operations will subsequently be performed to scale the array size, rotate the panel, and slide the panel to its final position. For indices 1 to 547, Table 1 has a north-east-down row vector.

TABLE 1

| Index | North | East | Down |
|---|---|---|---|
| 1 | 0 | 0 | 0 |
| 2 | 0.5 | 0.866 | 0 |
| 2 | 1 | 0 | 0 |
| 4 | 0.5 | −0.866 | 0 |
| 5 | −0.5 | −0.866 | 0 |
| 6 | −1 | 0 | 0 |
| 7 | −0.5 | 0.866 | 0 |
| . . . | . . . | . . . | . . . |
| 547 | −11.2583 | 6.5 | 0 |

The discussion will now turn to building a physical array. Continuing the example above, assume that the wavelength is 1 unit. This assumption will provide the 2-D equivalent of λ/2 used in 1-D arrays. Each of the coordinates is further multiplied by 0.3. While not strictly necessary, and in certain embodiments may be omitted, this operation avoids grating lobes.

It is also desirable to apply an amplitude taper in order to keep sidelobes to an acceptable level. For example, by reducing the gain at the edge of the array, the total gain may be lessened, while widening the main lobe, side lobe levels may be reduced. This operation may not be optimal (e.g., some elements may not exhibit maximum gain) but is performed to avoid unnecessary complication within the example.

With regards to FIG. 6B, the array elements of FIG. 6A are illustrated after shrinking by a factor of 0.3. The amplitude is further plotted on the height dimension. As discussed above, the edges are also attenuated to reduce sidelobes.

Continuing the process of building the physical array, a pair of panels (referred to as Panel 1 and Panel 2) is arranged by rotation and translation to face north and east with a selected slope from vertical. In this example, the slope is 20 degrees from vertical, yielding a configuration is as if the panels were on the faces of a (truncated) pyramid house. To accomplish the rotation and translation, a rotation matrix, R, and a translation vector, c, are applied to every position vector, xᵢ, yielding respective new element locations, x′ᵢ (Equation 1.9):

uᵢ→xᵢR+c=x′ᵢ (1.9)

By stacking row vectors into a matrix, X, the rotation may be applied en-masse using a matrix-matrix multiplication (Equation 1.10):

$${X}^{′} = XR + C \\ where \\ {X}^{′} = ( \begin{matrix}{x}_{1}^{′} \\ ⋮ \\ {x}_{i}^{′}\end{matrix} ) \\ and \\ C = ( \begin{matrix}c \\ ⋮ \\ c\end{matrix} ) \qquad ( 1.10 )$$

For the north facing panel (Panel 1), rotation is performed by 70 degrees about the east axis. This can be performed by right-multiplying each row by R and adding c (Equation 1.11):

$$R = ( \begin{matrix}0.3420 & 0 & 0.9397 \\ 0 & 1 & 0 \\ - 0.9397 & 0 & 0.3420\end{matrix} ) \qquad ( 1.11 )$$

For the east facing panel (Panel 2), rotation is performed by 90 degrees in azimuth, then 70 degrees in rotation (Equation 1.12):

$$R = ( \begin{matrix}0 & 0.3420 & 0.9397 \\ - 1 & 1 & 0 \\ 0 & - 0.9397 & 0.3420\end{matrix} ) \qquad ( 1.12 )$$

These two panels are lists of element position rows. The composite array is formed by simply concatenating the two panel element lists. FIG. 6C shows the two panel composite array element placement.

Further continuing the process of building the physical array, the direction vector is introduced to set the beam steering phase shifts. Assume the beam steering direction is 30 degrees azimuth and 10 degrees elevation. The unit length of the direction vector is given by Equation 1.13:

u*=(0.8529 0.4924 −0.1736) (1.13)

in the north-east-down coordinate system of FIGS. 6A-6C. It may be understood that, unless otherwise noted, a starred direction vector, u*, denotes the actual signal direction, while a non-starred u is any direction, which may or may not correspond to the signal direction.

The distance advancement from the origin point is calculated by taking the dot product between the desired beam steering direction and the element positions (i.e., the direction vector and the respective position vectors), Equation 1.14:

dᵢ=xᵢ·u* (1.14)

The phase advance, φᵢ due to the element location is given by Equation 1.15:

φᵢ=kxᵢ·u* (1.15)

With k=2π/λ. The net phase shift at each element is set to offset the advance.

After the phase shifter is setup, the signal phases are all the same when they are combined. The total signal gain is simply the sum of the element gains.

In order to produce an antenna pattern, the phases are kept fixed and the direction vector is varied. The direction vector is varied using differential mapping of the nominal beam steering direction (Equation 1.16):

$$u = u exp D , \\ D = ( \begin{matrix}0 & 0 & - y \\ 0 & 0 & z \\ y & - z & 0\end{matrix} ) \qquad ( 1.16 )$$

where y and z are the steering angles (in the tangent space).

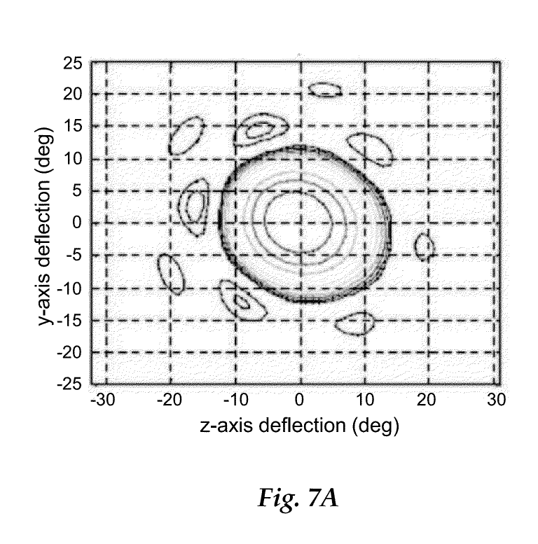

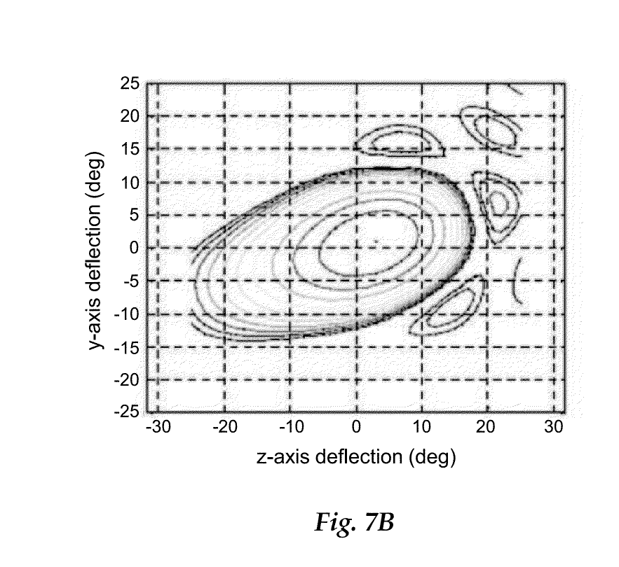

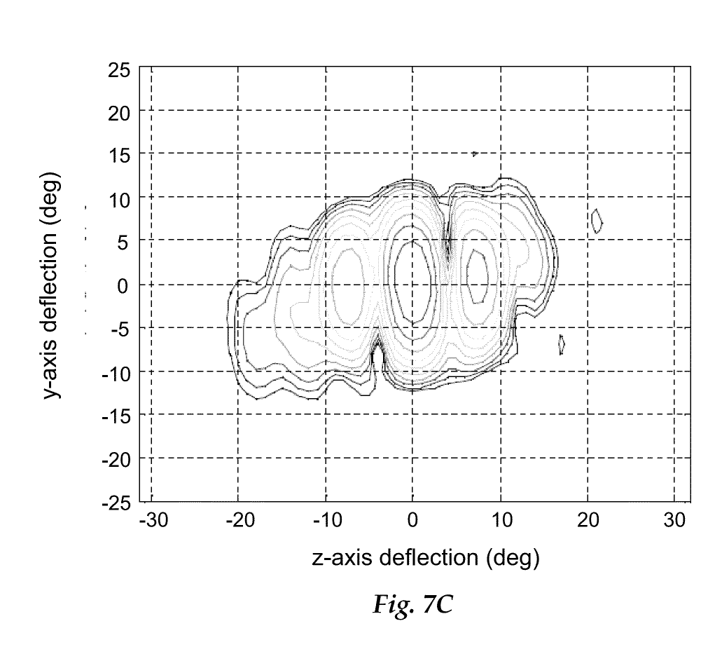

FIGS. 7A and 7B show the beam patterns for Panel 1 and Panel 2, respectively. The phase lines up at the center. The cosine of the scan angle amplitude further rolls off for pointing off the panel normal vector. Additionally, circular Taylor weighting is also present. Panel 1 is close to broadside while Panel 2 has more scan angle and, thus, an elongated pattern.

FIG. 7C shows the combined antenna array pattern of the two panels working together and coherently combined. There is some inter-panel interference which makes the notches in the main (single) panel lobe.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method operations can be performed by one or more programmable processors executing a computer program to perform functions of the invention by operating on input data and generating output. Method operations can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

The terms comprise, include, and/or plural forms of each are open ended and include the listed parts and can include additional parts that are not listed. The term and/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method of beam steering in a phased array, comprising:
storing, by a first antenna array element, a first position vector, x₁, representing a position of an antenna of the first antenna array element with respect to a defined origin and coordinate system;
storing, by a second antenna array element, a second position vector, x₂, representing a position of an antenna of the second antenna array element with respect to the defined origin and coordinate system;
broadcasting, by an array controller, a signal including a direction vector, u, to each of the first and second antenna array elements, wherein the direction vector is representative of a command steering direction;
calculating, by one or more first processors of the first array antenna element, a first phase, φ₁, based upon the first position vector and the direction vector; and
calculating, by one or more second processors of the second array antenna element, a second phase, φ₂, based upon the second position vector and the direction vector.

2. The method of claim 1, wherein storing the first position vector by the first antenna array element comprises storing the first position vector in a first storage device in communication with the first antenna array element and wherein storing the second position vector by the second antenna array element comprises storing the second position vector in a second storage device in communication with the second antenna array element, wherein the first and second storage devices are different.

3. The method of claim 1, further comprising:
emitting, by the first antenna, a first electromagnetic wave based upon the first phase; and
emitting, by the second antenna, a second electromagnetic wave based upon the second phase.

4. The method of claim 3, wherein the first phase is calculated according to Formula (1) and the second phase is calculated according to Formula (2), Formulas (1) and (2) given by:
$$\begin{matrix}{φ}_{1} = ( \frac{2 π}{λ} ) ( \frac{{x}_{1} \cdot u}{\vert u \vert} ) & ( 1 ) \\ {φ}_{2} = ( \frac{2 π}{λ} ) ( \frac{{x}_{2} \cdot u}{\vert u \vert} ) & ( 2 )\end{matrix}$$
where λ is the wavelength of the first and second electromagnetic waves.

5. The method of claim 1, wherein the position vectors x₁ and x₂ and the direction vector u are represented in a Cartesian coordinate system.

6. The method of claim 1, wherein the position vectors x₁ and x₂ and the direction vector u are not represented in an Euler angle-based coordinate system.

7. The method of claim 1, wherein broadcasting the signal including the direction vector comprises broadcasting the signal simultaneously to the antennas of the first and second antenna array elements.

8. The method of claim 1, wherein calculating the first phase and the second phase does not include calculating the first phase and the second phase by the array controller.

9. A phased array, comprising:
an antenna array including a plurality of antenna array elements;
an array controller adapted to broadcast, to each of the plurality of antenna array elements, a signal including a direction vector, u, wherein the direction vector represents a selected steering direction of the antenna array;
wherein each antenna array element further comprises:
an antenna;
a storage device adapted to maintain a position vector, x, representing a position of the antenna with respect to a defined origin and the direction vector, u; and
a computing device in communication with the storage device, the computing device adapted to calculate a phase φ for the antenna of its antenna array element based upon the position vector of the antenna of its antenna array element and the direction vector.

10. The phased array of claim 9, wherein the array controller is adapted to broadcast the direction vector to each of the plurality of antenna array elements simultaneously.

11. The phased array of claim 9, wherein each antenna of the plurality of antenna array elements is further adapted to output an electromagnetic wave based upon the respective phase calculated by its computing device.

12. The phased array of claim 9, wherein the phase of the i^{th} antenna array element is calculated, by the computing device of the i^{th} antenna array element, according to Formula (1):
$${φ}_{1} = ( \frac{2 π}{λ} ) ( \frac{{x}_{1} \cdot u}{\vert u \vert} ) \qquad ( 1 )$$
wherein:
φᵢ is the phase calculated by the i^{th} computing device of the i^{th} antenna array element;
−λ is the wavelength of the electromagnetic wave output by the antenna of the i^{th} antenna array element;
xᵢ is the position vector of the antenna of the i^{th} array element.

13. The phased array of claim 9, wherein at least a portion of the antennas of the plurality of array elements are not spaced according to a regular pattern.

14. The phased array of claim 9, wherein at least a portion of the antennas of the plurality of array elements are not positioned within a single plane.

15. A non-transitory computer-readable medium having computer-executable program codes embedded thereon for steering a phased array, the computer-readable program codes including instructions that, when executed by one or more processors, cause the one or more processors to:
store, at a first antenna array element, a first position vector, x₁, the first position vector representing the position of an antenna of the first antenna array element with respect to a defined origin;
store, at a second antenna array element, a second position vector x₂, the second position vector representing the position of an antenna of the second antenna array element with respect to the defined origin;
broadcast, to each of the first and second antenna elements, a direction vector, u, representative of a command steering direction;
calculate, at the first antenna system, a first phase, φ₁, based upon the first position vector and the direction vector; and
calculate, at the second antenna system, a second phase, φ₂ based upon the second position vector and the direction vector.

16. The computer-readable medium of claim 15, further including instructions that, when executed by the one or more processors, cause the antenna of the first antenna array element to emit a first electromagnetic wave based upon the first phase and cause the antenna of the second antenna array element to emit a second electromagnetic wave based upon the second phase.

17. The computer-readable medium of claim 16, wherein the first phase is calculated according to Formula (1) and the second phase is calculated according to Formula (2), Formulas (1) and (2) given by:
$$\begin{matrix}{φ}_{1} = ( \frac{2 π}{λ} ) ( \frac{{x}_{1} \cdot u}{\vert u \vert} ) & ( 1 ) \\ {φ}_{2} = ( \frac{2 π}{λ} ) ( \frac{{x}_{2} \cdot u}{\vert u \vert} ) & ( 2 )\end{matrix}$$
wherein λ is the wavelength of the electromagnetic wave emitted by the first and second antenna arrays.

18. The computer-readable medium of claim 15, wherein the first and second position vectors and the direction vector are represented in a Cartesian coordinate system.

19. The computer-readable medium of claim 15, wherein the first and second position vectors and the direction vector are not represented in an Euler angle-based coordinate system.

20. The computer-readable medium of claim 15, wherein broadcasting the direction vector comprises broadcasting the direction vector simultaneously to the first and second antenna array elements.
